(19) United States
(12) Patent Application Publication
(10) Pub. No.: US 2025/0383424 A1
(43) Pub. Date: Dec. 18, 2025

(54) MODULATION FOR A FREQUENCY MODULATED CONTINUOUS WAVE RADAR SYSTEM

(71) Applicant: Infineon Technologies AG, Neubiberg (DE)

(72) Inventors: Dmytro CHERNIAK, Villach (AT); Nicolo GUARDUCCI, Linz (AT); Luigi GRIMALDI, Villach (AT); Fabio VERSOLATTO, Buttrio (IT); Dominik AMSCHL, Wundschuh (AT); Thomas MALETZ, Unterhaching (DE)

(21) Appl. No.: 19/233,852

(22) Filed: Jun. 10, 2025

(30) Foreign Application Priority Data
Jun. 17, 2024 (DE) 102024205578.6

(51) Int. Cl. G01S 7/35; G01S 13/58

(52) U.S. Cl. CPC G01S 7/35; G01S 13/584

(57) ABSTRACT

A mechanism for generating a modulation signal for use in a radar system. The modulation signal includes a sequence of chirps. Each chirp includes an active period, a transition period and an idle period. During the active period, the frequency of the chirp moves from a start frequency to an end frequency. During the transition period, the frequency of the chirp moves towards the start frequency of the next chirp. The rate of change of the frequency, during the transition period, is different for different chirps of the modulation signal.

### CROSS-REFERENCE TO RELATED APPLICATION

This application claims priority to Germany Patent Application No. 102024205578.6 filed on Jun. 17, 2024, the content of which is incorporated by reference herein in its entirety.

### TECHNICAL FIELD

The present disclosure relates to the field of radar systems, and in particular to frequency modulated continuous wave (FMCW) radar systems.

### BACKGROUND

In any radar system, the radar system will generate an output radar signal and obtain a reflected radar signal. The reflected radar signal is processed to identify the presence and/or movement of objects in the field of view of the radar system.

One known type of radar system is a frequency modulated continuous wave (FMCW) radar system. In some types of FMCW radar systems, there is a desire to generate and output a radar signal that includes a series or sequence of chirps. In each chirp, a frequency of the radar signal gradually changes. This gradual change in the radar signal facilitates range identification by effectively tracking a return time for different frequencies in each chirp. The use of a series of chirps also facilitates movement detection by tracking changes in a return time for a same frequency across different chirps, e.g., using Doppler-based tracking.

It is common to use a phase locked loop (PLL) to generate the radar signal for output by (an antenna system of) the radar system. The PLL typically receives a modulation signal, from a modulation arrangement, and generates the radar signal responsive to the modulation signal—e.g., to track the frequency defined by the modulation signal.

One known effect of a phase locked loop is the generation of spurious tones (also known as “spurs”) in the output signal of the phase locked loop, which (in the context of a radar system) is the radar signal. This is particularly disadvantageous for FMCW radar systems, as spurs in an output radar signal output by the FMCW radar system will resemble, in a received radar signal values that indicate a movement of an object reflecting the output radar signal. This can lead to false detection of targets.

There is therefore a desire to reduce the occurrence and/or effect of spurs in a radar signal and/or a received radar signal of an FMCW radar system.

### SUMMARY

Examples disclosed herein propose a modulation arrangement for a frequency-modulated continuous-wave radar system, wherein the modulation arrangement is configured to generate a modulation signal including a sequence of chirps over time.

Each chirp includes: an active period, during which the modulation arrangement is configured to move the frequency of the modulation signal from a first frequency of the chirp to a second frequency of the chirp; after the active period, a transition period, during which the modulation arrangement is configured to move the frequency of the modulation signal from the second frequency of the chirp towards the first frequency of the following chirp in the sequence of chirps; and after the transition period, an idle period.

The modulation arrangement is configured such that an average rate of change of the frequency of the modulation signal during the transition period is different in different chirps of the sequence of chirps.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a frequency-modulated continuous wave (FMCW) radar system.

FIG. 2 illustrates a modulation signal.

FIG. 3 illustrates a phase locked loop.

FIG. 4 illustrates a variation of a modulation signal.

FIG. 5 illustrates another variation of a modulation signal.

FIG. 6 illustrates a modulation arrangement.

### DETAILED DESCRIPTION

The examples described herein provide a mechanism for generating a modulation signal for use in a radar system. The modulation signal comprises a sequence of chirps. Each chirp includes an active period, a transition period and an idle period. During the active period, the frequency of the chirp moves from a start frequency to an end frequency. During the transition period, the frequency of the chirp moves towards the start frequency of the next chirp. The rate of change of the frequency, during the transition period, is different for different chirps of the modulation signal.

FIG. 1 illustrates a portion of a frequency-modulated continuous wave (FMCW) radar system 100 in which implementations may be employed. Although the function and operation of an FMCW radar system is well known in the art, a very brief description of conventional elements of such a system is hereafter provided for improved contextual understanding.

The system 100 comprises a modulation arrangement 110, a phase-locked loop 120, an antenna system 130 and a receiver arrangement 140.

The modulation arrangement 110 is configured to generate a modulation signal SM comprising a sequence or series of chirps. A chirp is defined as a portion of a signal that starts at a first frequency and moves (adjusts or shifts) to a second, different frequency.

Approaches and circuitry capable of producing a signal having a varying and controllable frequency are well known in the art. For instance, the modulation arrangement 110 may comprise a microprocessor or other digital circuitry that outputs, via a digital to analog converter or within the digital domain, a signal having a controllable frequency. Such techniques are well established in the field, and are not described in detail for the sake of conciseness.

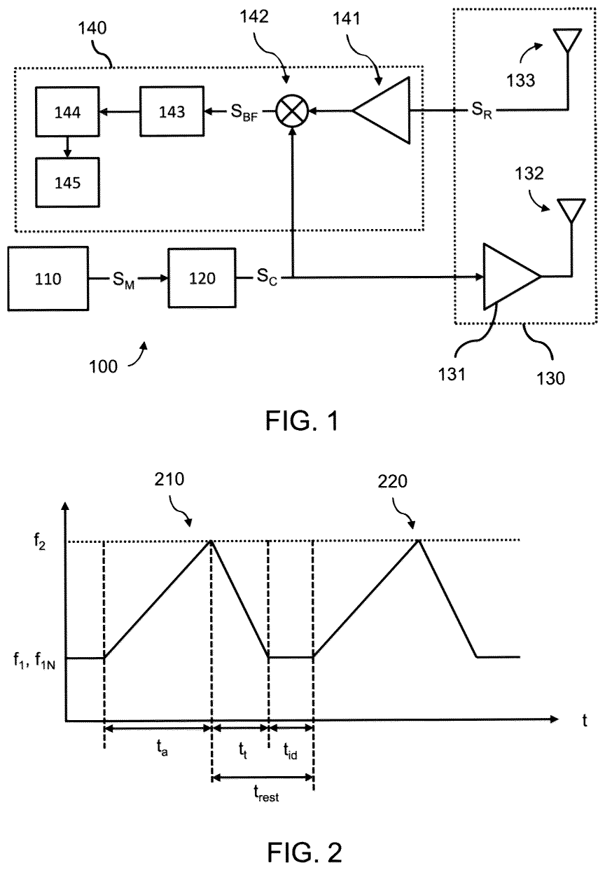

FIG. 2 illustrates an example of a modulation signal S_{M}, formed of a sequence of chirps 210, 220. The sequence of chirps may sometimes be referred to as a frame. The sequence of chirps may for example include 64 or more, 128 or more, 256 or more 512 or more chirps. FIG. 2 illustrates a frequency f of the modulation signal S_{M} over time t. In the illustrated example, each chirp begins at a same first frequency f₁ and rises to a same second frequency f₂. However, this is not essential, and in other examples different chirps may have different first and/or second frequencies.

Turning back to FIG. 1, the modulation signal SM controls the operation of the phase-locked loop 120. In particular, the phase-locked loop 120 is configured to generate a chirp signal S_{C} at an operating frequency of the phase-locked loop.

The modulation arrangement 110 and the phase-locked loop 120 together form a radar signal generator that generates a chirp signal for output by the radar system.

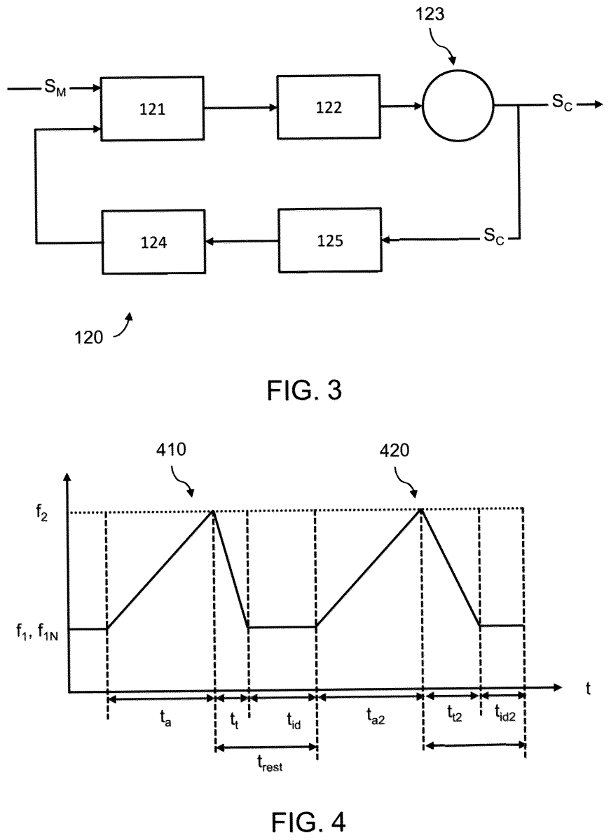

FIG. 3 illustrates one example of a phase-locked loop 120 that comprises a time-to-digital converter (TDC) 121 (also known as a phase detector), a digital loop filter (DLF) 122, an oscillator 123 (such as a voltage controlled oscillator) and (if required) a digital-to-time converter (DTC) 124.

The time-to-digital converter 121 functions to determine a phase difference (or phase error) between the modulation signal S_{M} and the chirp signal S_{C}. In this way, the time-to-digital converter 121 functions as the phase frequency detector of the phase-locked loop 120. The digital loop filter 122 filters this phase error and the oscillator 123 generates the chirp signal responsive to the filtered phase error. This can, for instance, be performed by controlling a bias voltage applied to a voltage controlled oscillator for generating the chirp signal S_{C}.

The digital-to-time converter 124 is positioned in the feedback loop that provides the generated chirp signal S_{C} back to the TDC 121. This can be used, for instance, to convert a sampled chirp signal S_{C} back to the time domain.

Commonly, one or more dividers 125 (such as one or more multiple modulus dividers) are used such that the frequency of the chirp signal S_{C} produced by the phase-locked loop 120 is a multiple of the frequency of the modulation signal. For instance, a divider 125 may be positioned within the feedback loop of the chirp signal to the comparative element.

Turning back to FIG. 1, the chirp signal S_{C} is passed to an antenna system 130 for output. The antenna system may comprise one or more amplifiers 131 (e.g., power amplifiers) for amplifying the chirp signal. The antenna system 130 comprises one or more first antennae 132 for broadcasting the (e.g., amplified) chirp signal.

The antenna system 130 also comprises one or more second antennae 133 for receiving echoes of the broadcast chirp signal. The second antenna(e) 133 generates an electrical signal, known as a receive signal S_{R}, responsive to any received echoes.

The receiver arrangement 140 receives the receive signal S_{R}, optionally amplifies the receive signal (e.g., using a low noise amplifier 141), and combines or mixes, using a mixer 142, the (e.g., amplified) receive signal Sᵣ with the chirp signal S_{C}. The mixing process generates a signal having a phase equal to a difference in phase between the chirp signal and the receive signal, which is called the beat frequency signal S_{BF}. The beat frequency signal may then be filtered by a low-pass filter 143 (of the receiver arrangement 140) and converted into a digital signal by an analog-to-digital converter 144 (of the receiver arrangement 140).

The digital signal can be appropriately processed by digital signal processing circuitry 145 (of the receiver arrangement) to determine a distance between the system 100 and surrounding objects and/or a speed/velocity of objects in the vicinity of the system 100. In particular, the digital signal may be processed using a Fourier-based transform technique to produce a dataset defining a velocity with respect to distance of elements in the vicinity of the system 100. More specifically, this dataset may be labelled a Range-Doppler map, which when graphically represented in two-dimensions represents (on one axis) Range information of any detected objects and (on another axis) Doppler information represents a velocity or speed of any detected object.

Approaches for processing a beat frequency signal to produce or determine distance and/or speed/velocity information for detected objects are well known in the art. For instance, one example technique are described by Milovanovic, Vladimir. “On fundamental operating principles and range-doppler estimation in monolithic frequency-modulated continuous-wave radar sensors.” Facta Universitatis, Series: Electronics and Energetics 31.4 (2018): 547-570.

It is recognized that one disadvantage of a phase locked loop, particularly a digital phase locked loop, is the presence or occurrence of spurs or spurious content. These spurs result from non-ideal effects within the phase-locked loop 120, such as in the quantization of the modulation signal and/or chirp signal (when performing a comparison) and/or a non-linearity of one or more digital-to-time or time-to-digital converters of the phase-locked loop 120. Other examples and causes for spurs are well known to the skilled person.

These spurs result in artifacts within any broadcast signal by the antenna system, and therefore corresponding artifacts within the receive signal. These artifacts within the receive signal resemble, or have similar characteristics, to objects. In other words, artifacts resulting from spurs in the chirp signal S_{C} result in artifacts in the receive signal that have similar characteristics to reflections from objects (in the vicinity of the system) represented in the receive signal.

The present disclosure provides a mechanism for mitigating these spurs. In particular, the proposed approach aims to diminish the impact of spurs in the receive signal (e.g., and any produced Range-Doppler map) using variation to one or more of several chirp parameters while having no penalty on any other FMCW radar system parameter (e.g., occupied BW, coherency, etc.) and without demanding any correction or additional data processing for computation of a Range-Doppler map.

More particularly, the present implementation proposes to introduce variation into the sequence of chirps of the modulation signal in order to reduce the presence of spurious content in the (e.g., amplified) chirp signal. By introducing variation, the build of spurs is reduced (e.g., spurious content is spread across frequencies, flattening any spur).

Turning once again to FIG. 2, it has been recognized that a chirp 210 can be sub-divided into (at least) three periods, namely: an active period tₐ; a transition period tₜ; and an idle period t_{id}. The transition period tₜ and idle period t_{id} may be together considered to be a rest period tᵣₑₛₜ.

The active period is temporally before the transition period. The transition period is temporally before the idle period. Thus, the chirp moves through a sequence of periods, starting with the active period, then moving to the transition period, then moving to the idle period. In some examples, although not illustrated, there may be additional idle periods (e.g., before the active period or between the active period and the transition period).

During the active period of a chirp, the modulation arrangement is configured to move the frequency of the modulation signal from a first frequency f₁ (of/for the chirp) to a second frequency f₂ (of/for the chirp). This movement may be a smooth movement, e.g., a ramp, or a stepped movement. In some examples, the chirp may follow during the active period a linear change (in the case of a stepped movement the beginning or center of each step may lie on a linear frequency ramp). Of course, non-ideal effects may mean that the movement is curved, rather than straight (as illustrated). The active period provides the portion which is used for evaluation such as for detecting objects and determining ranges of detected objects. Periods outside the active period such as the transition period and the idle period are not used for determining ranges of the detected objects. The active period is in examples longer than the transition period. In examples, the active period of one chirp of the reflected signal is down-converted using the active period of the same chirp of the transmitted signal. The down-converted signals corresponding to all chirps of the sequence of chirps are sampled and a discrete Fourier Transformation (DFT) is performed over the data corresponding to the sequence of chirps in order to determining ranges or velocities of detected objects. The sampled data over all chirps of one sequence of chirps therefore constitute (after the DFT) one Range-Doppler Map.

In the illustrated example, the second frequency of each chirp is greater than the first frequency of each chirp, such that (during the active period) the frequency of the modulation signal rises for all chirp of the sequence. However, this is not essential. In any given chirp, the first frequency f₁ may be greater than the second frequency f₂ or vice versa. It will be understood that, for each chirp, the first frequency is different to the second frequency.

In some examples, for ease of processing, the first frequency of each chirp is substantially the same and the second frequency of each chirp is substantially the same. However, this is not essential, and the first/second frequencies of each chirp may differ in different chirps, depending upon the specific implementation.

During the transition period, the modulation arrangement is configured to move the frequency of the modulation signal from the second frequency f₂ (of/for the chirp) towards a first frequency f_{1F} of a next or following chirp in the series or sequence of chirps. In this way, during the transition period, the modulation arrangement moves the frequency of the modulation signal from a second frequency f₂ to a third frequency. In some examples, the third frequency is equal to the first frequency of the next chirp in the sequence of chirps, although this is not essential as later described.

This movement may be a smooth movement, e.g., a ramp, or a stepped movement. Of course, non-ideal effects may mean that the movement is curved, rather than straight (as illustrated).

In examples in which the first frequency f₁ of a chirp lies in same direction from a second frequency f₂ of a chirp as the first frequency f_{1F} of a next chirp (e.g., both first frequencies are either greater than or smaller than the second frequency), then the transition period tₜ may be known as a flyback period.

Thus, if the first frequency f₁, f_{1N} of adjacent chirps is the same, then during the transition period the modulation arrangement may move the frequency of the modulation signal from the second frequency f₂ back to the first frequency f₁.

During the idle period, there may be significantly less movement of the frequency of the modulation signal (e.g., than during the active period or the transition period). In particular, during the idle period, the (average) rate of movement of the frequency of the modulation signal may be less than a movement during the transition period, e.g., no less than 5 times less, e.g., no less than 10 times less. In particular, in each chirp, the (average) rate of change of the frequency during the transition period may be no less than 5 times greater (e.g., no less than 10 times greater) than the (average) rate of change of the frequency during the idle period. In some examples, during the idle period, the modulation arrangement is configured to effectively maintain the frequency of the modulation signal (e.g., ±10% or more preferably ±5%).

The present disclosure proposes to vary the (average) rate of change of the frequency during the transition period tₜ for different chirps. In particular, the proposed modulation arrangement is configured such that an average rate of change of the frequency of the modulation signal (e.g., average rate of frequency change of the modulation signal) during the flyback period is different in different chirps of the sequence of chirps. In examples, the active period is however periodically repeated with the same rate of change of for all chirps of the sequence and within the same time frame. The shape of the active period is therefore in examples not changed for all chirps during one sequence of chirps and the active period is repeated with the same shape.

In some examples, the sequence of chirps comprises at least 10 different rates of change of the frequency during the transition period of all chirps of the sequence. Thus, at least 10 different rates of change of the frequency are implemented in the sequence of chirps. In some examples, the sequence of chirps comprises at least 20 different rates of change of the frequency during the transition period of all chirps of the sequence. In examples, the varying of the rate of change of the frequency during the transition period is provided to reduce the presence of spurious content and is therefore not initiated based on situations related to a detected object (e.g., a distance or relative velocity to the object, a number of objects etc.) or the appearing of other radar sources. The varying of the rate of change of the frequency during the transition period is therefore independent on parameters related to detected objects or the appearance of other radar sources. For example, even if no object is present or detected, the rate of change of the frequency during the transition period is changed in the context of the present disclosure.

In the context of the present disclosure, the average rate of change is defined as the arithmetic average (across the relevant period) of the rate of change. In a simple example, this can be, for instance, defined as the total change in frequency divided by the total duration of the relevant period (e.g., the transition period).

Thus, if during the transition period tₜ having a duration d₁ the frequency moves from a second frequency f₂ to a third frequency f₃, then the average rate of change RC may be defined as:

$$R C = \frac{{f}_{3} - {f}_{2}}{{d}_{1}} \qquad ( 1 )$$

However, other techniques for defining an average rate of change will be apparent to the appropriately skilled person.

For instance, as another example, a rate of change may be determined at each of a plurality of points in the transition period. The determined rates of changes may then be averaged to determine or calculate an average rate of change.

Preferably, the total duration of each chirp (e.g., the sum of the durations of the active period, the transition period and the idle period) is the same. This increases an ease of processing received signals, particularly if later producing a Doppler-Range map using a Fourier-based process.

Preferably, for each chirp, the sum of the duration of the transition period and the duration of the idle period (e.g., the duration of the rest period tᵣₑₛₜ) is the same. Similarly, for each chirp, the duration of the active period tₐ may be the same. In this way, the total duration of each chirp may be the same (e.g., a chirp repetition rate is kept substantially constant). This facilitates ease of processing the chirps, e.g., without needing expensive and/or complex circuitry for monitoring of the response signal. “Substantially” accounts for small tolerance errors and non-idealities (or other small fluctuations) that is typical in the field of signal generation. For example, “substantially” may mean within 5% of a target value or within acceptable tolerance margin of +/−5%.

One approach for controlling the rate of change (during the transition period) of the frequency of the modulation signal is fix the total change to the frequency of the modulation signal during the transition period of each chirp, but to adjust the ratio between the durations of the transition period and the idle period between different chirps. In particular, the total duration of the transition period and the idle period (e.g., the duration of the rest period) may be fixed, and the individual duration of the transition period may be controlled or defined for each chirp.

FIG. 4 illustrates an example of a modulation signal in which the rate of change of frequency, during a transition period, is different for different chirps 410, 420. This is achieved by varying the duration of the transition period tₜ, t₂, for different chirps. The rest period tᵣₑₛₜ, tᵣₑₛₜ₂ is the same for different chirps, such that varying the duration of the transition period(s) also varies the duration of the idle period t_{id}, t_{id2} of different chirps.

Thus, FIG. 4 illustrates a first chirp 410 of a modulation signal and a second (adjacent) chirp 420 of the modulation signal. The total duration of each chirp is the same. The duration of the active period tₐ, tₐ₂ of each chirp is the same. In each chirp, during the transition period, the frequency of the modulation signal is moved from a same second frequency to a same third frequency (which is identical to the first frequency). The duration of the transition period tₜ, tₜ₂ is different for the different chirps, such that the average rate of change of the frequency of the modulation signal is different during the transition periods of different chirps.

In one example employing this approach, there may be a plurality of predetermined or predefined time durations. For each chirp, one of these predetermined or predefined time durations may be selected as the duration of the transition period. The duration of the idle period may be automatically determined (e.g., to ensure a same fixed duration for the rest period).

The selection of one of the predetermined or predefined time durations may be in accordance with a predefined distribution scheme, e.g., to ensure or increase a likelihood of a spread of different durations for the transition period across different chirps (and therefore different rate of changes for the frequency during the transition period of different chirps). By way of example, the distribution scheme may be a uniform distribution scheme, such that each of the predetermined or predefined time durations are equally likely to be selected across a suitable large range. As another example, the distribution scheme may be a normal or Gaussian distribution scheme, such that values towards a center of the predetermined/predefined time durations are more likely to be selected.

In some examples, the selection of one of the predetermined/predefined time durations may be performed randomly or pseudorandomly, e.g., within the predefined distribution scheme (if present). This increases a spread of different rates of changes for improved reduction of spurs. In other examples, the selection of one of the predetermined/predefined time durations is performed according to a preset pattern, e.g., which ensures suitable variation in the rate of change of the frequency during the transition period of different chirps.

Preferably, the plurality of predetermined or predefined time durations includes at least 10 different numbers of time durations, e.g., at least 20 different numbers of time durations. In other words, across the sequence of chirps, at least 10 different numbers of time durations are applied as predetermined or predefined time durations. Thus, the across the sequence of chirps, the circuitry of the modulation arrangement 110 is configured to apply at least 10 different predetermined or predefined time durations. Thus, at least 10 chirps or at least 10 sets of chirps in the sequence of chirps with have different rates of change of the frequency during their respective transition periods. This improves a spread of the rate of change of the frequency during the transition period of different chirps, thereby reducing spurious content. The greater the number of different time durations, the greater the reduction to spurious content within the chirp signal over time.

In another example that employs the same approach, the modulation arrangement is configured to, for each chirp, determine the duration of the transition period by adding a randomly or pseudorandomly generated time duration to a baseline duration. This approach guarantees a minimum duration for the transition period (the baseline duration) whilst providing a mechanism for varying the duration of the transition period between different chirps (and therefore the rate of change of the frequency during the transition period of different chirps).

In one example, the modulation arrangement is configured to operate at a clock frequency. In this scenario, each randomly or pseudorandomly generated duration of time may have a period of an integer number multiplied by a duration of a cycle of the clock frequency. This provides an easily implementable mechanism for adjusting the duration of the transition period of different chirps.

The randomly or pseudorandomly generated time durations preferably includes at least 10 different numbers of time durations, e.g., at least 20 different numbers of time durations. In other words, across the sequence of chirps, at least 10 different numbers of time durations are applied as randomly or pseudorandomly generated time durations. Thus, the across the sequence of chirps, the circuitry of the modulation arrangement 110 is configured to apply at least 10 different randomly or pseudorandomly generated time durations. The greater the number of different time durations, the greater the reduction to spurious content within the chirp signal over time. This can be achieved by defining the bounds of the (pseudo) randomly generated time durations using well known principles and/or appropriate selection of a distribution of values that can be randomly/pseudorandomly generated.

The above-described approaches define techniques in which the rate of change of the frequency within the transition period (of each chirp) is controlled by controlling the duration of the transition period within each chirp. However, other implementations are possible.

For instance, in an alternative example, the duration of each transition period is fixed for all chirps and the change in frequency during the transition period is different for different chirps. Thus, if during the transition period, the frequency of the modulation signal changes from a second frequency to a third frequency, then the difference between the second and third frequencies may be different for different chirps.

In such examples, the idle period may be used to transition the frequency of the modulation signal from the third frequency to the first frequency of the next chirp.

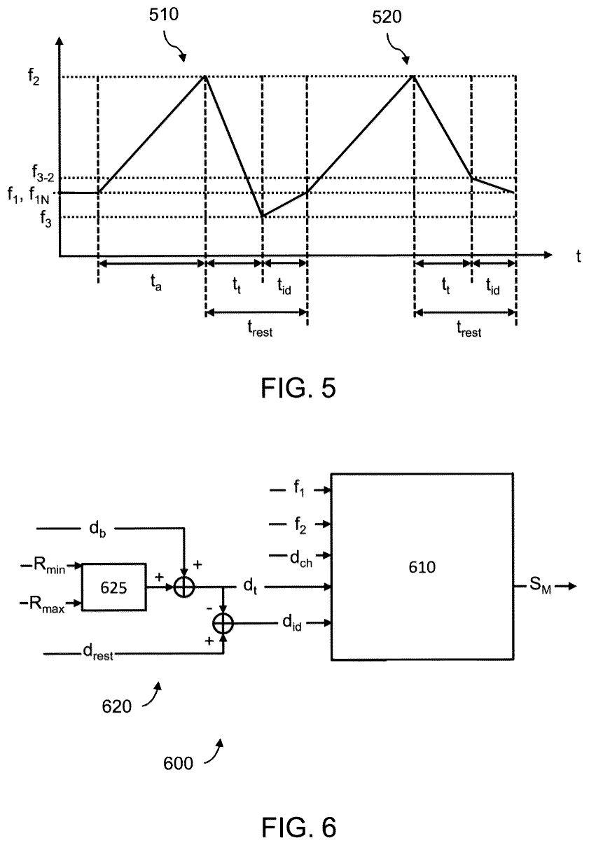

FIG. 5 illustrates an example of a modulation signal in which the rate of change of frequency, during a transition period, is different for different chirps 410, 420. This is achieved by varying the total change of frequency during the transition period tₜ, t₂, for different chirps, whilst fixing the duration of the transition period.

Thus, FIG. 5 illustrates a first chirp 510 of a modulation signal and a second (adjacent) chirp 520 of the modulation signal. The total duration of each chirp is the same. The duration of the active period tₐ of each chirp is the same. In each chirp, during the transition period, the frequency of the modulation signal is moved from a same second frequency to a different third frequency. The duration of the transition period tₜ is the same for the different chirps, such that the average rate of change of the frequency of the modulation signal is different during the transition periods of different chirps.

In this approach, the idle period t_{id} is used to transition the frequency of the modulation signal from the third frequency f₃, f₃₋₂ to the first frequency of the next chirp in the sequence or series of chirps. In the illustrated example, the first frequency of each chirp is the same (but this is not essential).

Of course, a combination of these approaches could be used. Thus, the duration of the transition period may be different for different chirps and the change in frequency during the transition period may be different for different chirps.

Previously described approaches define techniques for modifying or controlling the rate of change of the frequency, during the transition period, for different chirps.

In some examples, the modulation arrangement is configured such that, in the modulation signal, adjacent chirps have different rates of change of the frequency during the transition period. This further reduces a risk of spurs or spurious content within the chirp signal produced using the modulation signal.

However, this is not essential. In a more generic example, the modulation arrangement is configured such that, in the modulation signal, a rate of change of frequency during the transition period changes every N-th chirp, where N is any positive integer. In the preceding implementation, the value of N is 1, such that adjacent chirps have different rates of change of frequency during the transition period. However, the value of N may be greater than 1, e.g., for reduced processing requirements and/or more consistent chirps.

For the sake of completeness, FIG. 6 illustrates an example of a modulation arrangement 600 that may be employed in implementations.

The modulation arrangement 600 comprises a modulator 610 and a randomizing element 620.

The modulator 610 is configured to generate a chirp for the modulation signal S_{M} based on values of input parameters. These input parameters include a start frequency f₁ for the chirp (e.g., the first frequency of the chirp), an end/stop frequency f₂ for the chirp (e.g., the second frequency of the chirp), a total duration d_{ch} for the chirp (being the sum of the durations of the active period, the transition period and the idle period), a duration dₜ of the transition period, and a duration d_{id} of the idle period.

Circuitry capable of generating a chirp based on these parameters are well known in the art. The modulator will repeatedly generate a chirp, forming a sequence of chirps, using the current value(s) of the parameters.

For the purposes of the illustrated example, the modulator 610 is configured to iteratively generate a chirp. In each iteration, the chirp starts at the first frequency f₁ and moves to the second frequency f₂. The time taken to perform this movement (from f₂ to f₁) is defined by the total duration d_{ch} for the chirp, from which the duration dₜ of the transition period and a duration d_{id} of the idle period is subtracted to define the duration of the active period. The chirp then moves from the second frequency f₂ to the first frequency f₁. The time taken to perform this movement (from f₂ to f₁) is defined by the duration dₜ of the transition period. The chirp is then maintained at the first frequency f₁ for the idle period, defined by the duration d_{id} of the idle period, before the next iteration of generating a chirp is performed.

The randomizing element 620 is configured to (pseudo) randomly adjust or define the duration dₜ of the transition period and (corresponding) the duration d_{id} of the idle period.

The randomizing element 620 is configured to determine, for each chirp, a duration of the transition period by adding a randomly or pseudorandomly generated duration to a baseline duration d_{b}. A (pseudo) random generator 625 is configured to generate a randomly or pseudorandomly generated duration between a minimum R_{MIN} and maximum R_{MAX} duration. Approaches for randomly or psucdorandomly generating a value between two bounds are well established in the art.

The randomly or pseudorandomly generated duration is then summed with the baseline duration d_{b} to produce the duration dₜ of the transition period. The duration dₜ of the transition period is subtracted from a predefined duration dᵣₑₛₜ of the rest period to determine the duration d_{id} of the idle period.

It will be apparent that a new duration for the transition period (and idle period) is produced for every N-th chirp of the modulation signal, e.g., where the value of N is a positive integer, e.g., 1.

### Aspects

In addition to the above described aspects, the following aspects are disclosed.

Aspect 1 is a modulation arrangement for a frequency-modulated continuous-wave radar system, wherein the modulation arrangement is configured to generate a modulation signal comprising a sequence of chirps over time, wherein each chirp comprises an active period, during which the modulation arrangement is configured to move the frequency of the modulation signal from a first frequency of the chirp to a second frequency of the chirp; after the active period, a transition period, during which the modulation arrangement is configured to move the frequency of the modulation signal from the second frequency of the chirp towards the first frequency of the following chirp in the sequence of chirps; and after the transition period, an idle period, wherein the modulation arrangement is configured such that an average rate of change of the frequency of the modulation signal during the transition period is different in different chirps of the sequence of chirps.

Aspect 2 is the modulation arrangement of aspect 1, wherein, during the transition period of each chirp, the modulation arrangement is configured to move the frequency of the modulation signal from the second frequency of the chirp to the first frequency of the following chirp.

Aspect 3 is the modulation arrangement of any one of aspects 1 or 2, wherein a total time duration of each chirp is substantially the same.

Aspect 4 is the modulation arrangement of any one of aspects 1 to 3, wherein the first frequency of each chirp is substantially the same.

Aspect 5 is the modulation arrangement of any one of aspects 1 to 4, wherein the second frequency of each chirp is substantially the same.

Aspect 6 is the modulation arrangement of any one of aspects 1 to 5, wherein a time duration of the active period is substantially the same in each chirp.

Aspect 7 is the modulation arrangement of any one of aspects 1 to 6, wherein a time duration of the transition period is different in different chirps in the sequence of chirps.

Aspect 8 is the modulation arrangement of any one of aspects 1 to 7, wherein the average rate of change of the frequency of the modulation signal during the transition period is different in adjacent chirps of the sequence of chirps.

Aspect 9 is the modulation arrangement of any one of aspects 1 to 8, wherein a time duration of the transition period is different in adjacent chirps in the sequence of chirps.

Aspect 10 is the modulation arrangement of any one of aspects 1 to 9, wherein a combined duration of the transition period and the idle period is substantially the same in each chirp.

Aspect 11 is the modulation arrangement of any one of aspects 1 to 10, wherein during the transition period of each chirp, the modulation arrangement is configured to move the frequency of the modulation signal from the second frequency of the chirp to a third frequency of the chirp; and the difference between the second frequency and the third frequency is substantially the same for each chirp.

Aspect 12 is the modulation arrangement of any one of aspects 1 to 11, wherein the modulation arrangement is configured to, for each chirp, determine the duration of the transition period by assigning one of a plurality of predetermined time durations to the chirp.

Aspect 13 is the modulation arrangement of aspect 12, wherein the modulation arrangement is configured to, for each chirp, determine the duration of the transition period by using a distribution scheme to assign one of the plurality of predetermined time durations to the chirp based on a predefined distribution scheme.

Aspect 14 is the modulation arrangement of aspects 12 or 13, wherein the modulation arrangement is configured to, for each chirp, determine the duration of the transition period by assigning each chirp to one of the plurality of predetermined time durations in a random or pseudo-random manner.

Aspect 15 is the modulation arrangement of any one of aspects 1 to 11, wherein the modulation arrangement is configured to, for each chirp, determine the duration of the transition period by adding a randomly or pseudorandomly generated duration to a baseline duration.

Aspect 16 is the modulation arrangement of aspect 15, wherein the modulation arrangement comprises a digital PLL that operates at a clock frequency and wherein each randomly or pseudorandomly generated duration of time has a period of an integer number multiplied by a duration of a cycle of the clock frequency.

Aspect 17 is the modulation arrangement of aspect 15 or 16 wherein, across the sequence of chirps, the randomly or pseudorandomly generated time durations includes at least 10 different numbers of time durations.

Aspect 18 is a radar signal generator comprising: the modulation arrangement of any one of aspects 1 to 17; and a phase-locked loop configured to receive the modulation signal and generate a chirp signal responsive to the modulation signal generated by the modulation arrangement.

Aspect 19 is a frequency-modulated continuous-wave radar system radar system comprising: the radar signal generator of aspect 18; and an antenna system configured to receive the chirp signal and emit electromagnetic waves responsive to the received chirp signal.

Although specific aspects have been illustrated and described herein, it will be appreciated by those of ordinary skill in the art that a variety of alternate and/or equivalent implementations may be substituted for the specific aspects shown and described without departing from the scope of the present implementation. This application is intended to cover any adaptations or variations of the specific aspects discussed herein. Therefore, it is intended that this implementation be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all aspects and implementations outlined in the present document are principally intended expressly to be only for explanatory purposes to help the reader in understanding the principles of the proposed methods and systems. Furthermore, all statements herein providing principles, aspects, and implementations of the implementation, as well as specific aspects thereof, are intended to encompass equivalents thereof.

1. A modulation arrangement for a frequency-modulated continuous-wave radar system, the modulation arrangement comprising;
circuitry configured to generate a modulation signal comprising a sequence of chirps over time,
wherein each chirp in the sequence of chirps comprises:
an active period, during which the circuitry is configured to move a frequency of the modulation signal from a first frequency of the chirp to a second frequency of the chirp,
after the active period, a transition period, during which the circuitry is configured to move the frequency of the modulation signal from the second frequency of the chirp towards the first frequency of a following chirp in the sequence of chirps, and
after the transition period, an idle period, wherein the circuitry is configured such that an average rate of change of the frequency of the modulation signal during the transition period is different in different chirps of the sequence of chirps.

2. The modulation arrangement of claim 1, wherein, during the transition period of each chirp, the circuitry is configured to move the frequency of the modulation signal from the second frequency of the chirp to the first frequency of the following chirp.

3. The modulation arrangement of claim 1, wherein a total time duration of each chirp is substantially the same.

4. The modulation arrangement of claim 1, wherein the first frequency of each chirp is substantially the same.

5. The modulation arrangement of claim 1, wherein the second frequency of each chirp is substantially the same.

6. The modulation arrangement of claim 1, wherein a time duration of the active period is substantially the same in each chirp in the sequence of chirps.

7. The modulation arrangement of claim 1, wherein a time duration of the transition period is different in different chirps in the sequence of chirps.

8. The modulation arrangement of claim 1, wherein the average rate of change of the frequency of the modulation signal during the transition period is different in adjacent chirps of the sequence of chirps.

9. The modulation arrangement of claim 1, wherein a time duration of the transition period is different in adjacent chirps in the sequence of chirps.

10. The modulation arrangement of claim 1, wherein a combined duration of the transition period and the idle period is substantially the same in each chirp in the sequence of chirps.

11. The modulation arrangement of claim 1, wherein:
during the transition period of each chirp in the sequence of chirps, the modulation arrangement is configured to move the frequency of the modulation signal from the second frequency of the chirp to a third frequency of the chirp, and
the difference between the second frequency and the third frequency is substantially the same for each chirp in the sequence of chirps.

12. The modulation arrangement of claim 1, wherein the circuitry is configured to, for each chirp in the sequence of chirps, determine a duration of the transition period by assigning one of a plurality of predetermined time durations to the chirp.

13. The modulation arrangement of claim 12, wherein the circuitry is configured to, for each chirp in the sequence of chirps, determine the duration of the transition period by using a distribution scheme to assign one of the plurality of predetermined time durations to the chirp based on a predefined distribution scheme.

14. The modulation arrangement of claim 12, wherein the circuitry is configured to, for each chirp in the sequence of chirps, determine a duration of the transition period by assigning each chirp in the sequence of chirps to one of the plurality of predetermined time durations in a random or pseudo-random manner.

15. The modulation arrangement of claim 1, wherein the circuitry is configured to, for each chirp in the sequence of chirps, determine a duration of the transition period by adding a randomly or pseudorandomly generated time duration to a baseline duration.

16. The modulation arrangement of claim 15, wherein the modulation arrangement comprises a digital phase-locked Joop (PLL) that operates at a clock frequency, and
wherein each randomly or pseudorandomly generated time duration has a period of an integer number multiplied by a duration of a cycle of the clock frequency.

17. The modulation arrangement of claim 15, wherein, across the sequence of chirps, the circuitry is configured to apply at least 10 different numbers of time durations as randomly or pseudorandomly generated time durations.

18. A radar signal generator, comprising:
a modulation arrangement comprising circuitry configured to generate a modulation signal comprising a sequence of chirps over time.
wherein each chirp in the sequence of chirps comprises:
an active period, during which the circuitry is configured to move a frequency of the modulation signal from a first frequency of the chirp to a second frequency of the chirp.
after the active period, a transition period, during which the circuitry is configured to move the frequency of the modulation signal from the second frequency of the chirp towards the first frequency of a following chirp in the sequence of chirps, and
after the transition period, an idle period, wherein the circuitry is configured such that an average rate of change of the frequency of the modulation signal during the transition period is different in different chirps of the sequence of chirps; and
a phase-locked loop configured to receive the modulation signal and generate a chirp signal responsive to the modulation signal generated by the modulation arrangement.

19. A frequency-modulated continuous-wave radar system radar system, comprising:
a modulation arrangement comprising circuitry configured to generate a modulation signal comprising a sequence of chirps over time.
wherein each chirp in the sequence of chirps comprises:
an active period, during which the circuitry is configured to move a frequency of the modulation signal from a first frequency of the chirp to a second frequency of the chirp,
after the active period, a transition period, during which the circuitry is configured to move the frequency of the modulation signal from the second frequency of the chirp towards the first frequency of a following chirp in the sequence of chirps, and
after the transition period, an idle period, wherein the circuitry is configured such that an average rate of change of the frequency of the modulation signal during the transition period is different in different chirps of the sequence of chirps:
a phase-locked loop configured to receive the modulation signal and generate a chirp signal responsive to the modulation signal generated by the modulation arrangement: and
an antenna system configured to receive the chirp signal and emit electromagnetic waves responsive to the chirp signal.
